(19) United States
(12) Patent Application Publication
(10) Pub. No.: US 2025/0247551 A1
(43) Pub. Date: Jul. 31, 2025

(54) MULTIPLE MAPPINGS FOR A SINGLE SLICE OF A PICTURE

(71) Applicant: Telefonaktiebolaget LM Ericsson (publ), Stockholm (SE)

(72) Inventors: Rickard SJÖBERG, Stockholm (SE); Martin PETTERSSON, Vallentuna (SE); Christopher HOLLMANN, Uppsala (SE); Jacob STRÖM, Stockholm (SE)

(21) Appl. No.: 18/854,591

(22) PCT Filed: Apr. 8, 2022
(86) PCT No.: PCT/EP2022/059363

§ 371 Date: Oct. 7, 2024

(51) Int. Cl. H04N 19/176; H04N 19/159; H04N 19/174; H04N 19/70

(52) U.S. Cl. CPC H04N 19/176; H04N 19/159; H04N 19/174; H04N 19/70

(57) ABSTRACT

A method performed by a decoder for decoding, from a coded video bitstream, a first block of a first coded slice of a first picture and a current block of the first coded slice of the first picture. The method includes using first information from the coded video bitstream to obtain a first mapped residual block for the first block. The method also includes generating a first mapped reconstructed block using the first mapped residual block and a first prediction block for the first block. The method also includes using a first inverse mapping and the first mapped reconstructed block to generate a first output reconstructed block that is not identical to the first mapped reconstructed block. The method also includes using second information from the coded video bitstream to obtain a current mapped residual block for the current block. The method also includes generating a current mapped reconstructed block using the current mapped residual block and a current prediction block for the current block. The method also includes using a current inverse mapping and the current mapped reconstructed block to generate a current output reconstructed block that is not identical to the current mapped reconstructed block. The current inverse mapping is different than the first inverse mapping.

### TECHNICAL FIELD

Disclosed are embodiments related to picture encoding and decoding.

### BACKGROUND

### 1. HEVC and VVC

High Efficiency Video Coding (HEVC) is a block-based video codec standardized by ITU-T and MPEG that utilizes both temporal and spatial prediction. Spatial prediction is achieved using intra (I) prediction from within the current picture. Temporal prediction is achieved using uni-directional (P) or bi-directional inter (B) prediction on block level from previously decoded reference pictures. In the encoder, the difference between the original pixel data and the predicted pixel data, referred to as the residual, is transformed into the frequency domain, quantized and then entropy coded before transmitted together with necessary prediction parameters such as prediction mode and motion vectors, also entropy coded. The decoder performs entropy decoding, inverse quantization and inverse transformation to obtain the residual, and then adds the residual to an intra or inter prediction to reconstruct a picture.

MPEG and ITU-T are working on the successor to HEVC within the Joint Video Exploratory Team (JVET). The name of this video codec is Versatile Video Coding (VVC) and version 1 of VVC specification, which is the current version of VVC at the time of writing, has been published as Rec. ITU-T H.266/ISO/IEC 23090-3, “Versatile Video Coding,” 2020.

### 2. Components

A video (a.k.a., video sequence) consists of a series of pictures (a.k.a., images) where each picture consists of one or more components. Each component can be described as a two-dimensional rectangular array of sample values (a.k.a., pixel values). It is common that a picture in a video sequence consists of three components: one luma component (Y) where the sample values are luma values and two chroma components (Cb and Cr) where the sample values are chroma values. It is also common that the dimensions of the chroma components are smaller than the luma components by a factor of two in each dimension. For example, the size of the luma component of an HD picture may be 1920×1080 and the chroma components may each have the dimension of 960×540. Components are sometimes referred to as color components.

### 3. Blocks and Units

A block is a two-dimensional array of values (e.g., pixel values, code values, etc.). In video coding, each component is split into blocks and the coded video bitstream consists of a series of coded blocks. It is common in video coding that the picture is split into units that cover a specific area of the picture. Each unit consists of all blocks from all components that make up that specific area and each block belongs fully to one unit. The macroblock in H.264 and the Coding unit (CU) in HEVC are examples of units.

A block can alternatively be defined as a two-dimensional array that a transform used in coding is applied to. These blocks are known under the name “transform blocks.” Alternatively, a block can be defined as a two-dimensional array that a single prediction mode is applied to. These blocks can be called “prediction blocks”. In this application, the word block is not tied to one of these definitions but that the descriptions herein can apply to either definition.

### 4. Residuals, Transforms, and Quantization

A residual block consists of samples that represents sample value differences between sample values of the original source blocks and the prediction blocks. The residual block is processed using a spatial transform. In the encoder, the transform coefficients are quantized according to a quantization parameter (QP) which controls the precision of the quantized coefficients. The quantized coefficients can be referred to as residual coefficients. A high QP value would result in low precision of the coefficients and thus low fidelity of the residual block. A decoder receives the residual coefficients, applies inverse quantization and inverse transform to derive the residual block.

### 5. NAL Units

Both HEVC and VVC define a Network Abstraction Layer (NAL). All the data, i.e. both Video Coding Layer (VCL) or non-VCL data in HEVC and VVC is encapsulated in NAL units. A VCL NAL unit contains data that represents picture sample values. A non-VCL NAL unit contains additional associated data such as parameter sets and supplemental enhancement information (SEI) messages. The NAL unit in HEVC begins with a header which specifies the NAL unit type of the NAL unit that identifies what type of data is carried in the NAL unit, the layer ID and the temporal ID for which the NAL unit belongs to. The NAL unit type is transmitted in the nal_unit_type codeword in the NAL unit header and the type indicates and defines how the NAL unit should be parsed and decoded. The rest of the bytes of the NAL unit is payload of the type indicated by the NAL unit type. A bitstream consists of a series of concatenated NAL units.

### 6. Picture Header

VVC includes a picture header, which is a NAL unit having nal_unit_type equal to PH_NUT. The picture header is similar to the slice header, but the values of the syntax elements in the picture header are used to decode all slices of one picture. Each picture in VVC consist of one picture header NAL unit followed by all coded slices of the picture where each coded slice is conveyed in one coded slice NAL unit.

### 7. Parameter Sets

HEVC specifies three types of parameter sets: 1) the picture parameter set (PPS), 2) the sequence parameter set (SPS), and 3) the video parameter set (VPS). The PPS contains data that is common for a whole picture; the SPS contains data that is common for a coded video sequence (CVS); the VPS contains data that is common for multiple CVSs.

VVC also uses these parameter set types. In VVC, there is also an adaptation parameter set (APS) and a decoding parameter set (DPS). An APS may contain information that can be used for multiple slices and two slices of the same picture can use different APSs. The APS in VVC is used for signaling parameters for the adaptive loop filter (ALF), luma mapping with chroma scaling (LMCS) and scaling matrixes used for quantization. The APS syntax in VVC is shown below in Table 1:

TABLE 1
APS Syntax in VVC

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

The APS to use for a picture is signaled in the picture header associated with the picture. The relevant picture header syntax for LMCS is shown below in Table 2 where the syntax element ph_lmcs_aps_id is the APS ID corresponding to the syntax element aps_adaptation_parameter_set_id of the APS comprising the LMCS parameters to use for the picture.

TABLE 2

| | Descriptor |
|---|---|
| picture_header_structure( ) { | |
| ... | |
| if( sps_lmcs_enabled_flag ) { | |
| ph_lmcs_enabled_flag | u(1) |
| if( ph_lmcs_enabled_flag ) { | |
| ph_lmcs_aps_id | u(2) |
| if( sps_chroma_format_idc != 0 ) | |
| ph_chroma_residual_scale_flag | u(1) |
| } | |
| } | |

A DPS consists of information specifying the “worst case” in terms of profile and level that the decoder will encounter in the entire bitstream.

Both HEVC and VVC allow certain information (e.g. parameter sets) to be provided by external means. “By external means” should be interpreted as the information is not provided in the coded video bitstream but by some other means not specified in the video codec specification, e.g. via metadata possibly provided in a different data channel, as a constant in the decoder, or provided through an API to the decoder.

### 8. Slices

The concept of slices in HEVC divides the picture into independently coded slices, where decoding of one slice in a picture is independent of other slices of the same picture. Different coding types could be used for slices of the same picture, i.e. a slice could either be an I-slice, P-slice or B-slice. One purpose of slices is to enable resynchronization in case of data loss. In HEVC, a slice is a set of one or more CTUs.

In the current version of VVC, a slice is defined as an integer number of complete tiles or an integer number of consecutive complete CTU rows within a tile of a picture that are exclusively contained in a single NAL unit. A picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early version of the VVC draft specification, slices were referred to as tile groups.

9. Luma Mapping with Chroma Scaling (LMCS)

A coding tool that has been introduced in VVC is the “luma mapping with chroma scaling (LMCS)” tool, which is described in Lu, T., et al., “Luma Mapping with Chroma Scaling in Versatile Video Coding,” 2020 Data Compression Conference (DCC), 2020, pp. 193-202 (hereafter “Lu”). The LMCS tool employs a mapping mechanism to map luma code values from an input set of luma code values to an output set of luma code values. Code values of the input set can be said to be code values in a “mapped domain” and code values of the output set are in an “output domain.”

The main purpose of the luma mapping is to enable stretching or compacting of the code value range to use it more efficiently. A first use-case for 10-bit video using the normal code value range of 64 to 940 is to use the full range of 0 to 1023 in the decoding process and map this to the normal range before output. A second use is for video that that use only a relatively narrow range of code values. Then luma mapping can enable use of an expanded range in the mapped domain.

### SUMMARY

Certain challenges presently exist. For instance, in VVC, the LMCS tool is restricted to one mapped domain per picture (i.e., one mapping mechanism). The lack of supporting multiple mapping mechanisms (e.g., multiple mapping functions) makes the LMCS tool less versatile than it could otherwise be. For instance, if the mapping is such that coded values x−2, x, x+2 in the mapped domain corresponds to output domain values y−1, y, y+1, then the values in the mapped domain are represented more sparsely than they are in the output domain. This means that a value equal to y is coded with higher fidelity due to the mapping than it would have been without LMCS. The mapping therefore can enable coding of samples representing e.g. dark pixels in a picture with higher fidelity than bright pixels at the same QP value, or the other way around. However, because there is only one mapping in each picture, local fidelity adaptation is severely restricted and only possible at the picture level (by using a suitable mapping for the picture) and the block level (by using the block-based QP value). However, the QP value always affect the full coded value range and cannot target, for example, only dark samples.

Accordingly, in one aspect there is provided a method performed by a decoder for decoding, from a coded video bitstream, a first block of a first coded slice of a first picture and a current block of the first coded slice of the first picture. The method includes using first information from the coded video bitstream to obtain a first mapped residual block for the first block. The method also includes generating a first mapped reconstructed block using the first mapped residual block and a first prediction block for the first block. The method also includes using a first inverse mapping and the first mapped reconstructed block to generate a first output reconstructed block that is not identical to the first mapped reconstructed block. The method also includes using second information from the coded video bitstream to obtain a current mapped residual block for the current block. The method also includes generating a current mapped reconstructed block using the current mapped residual block and a current prediction block for the current block. The method also includes using a current inverse mapping and the current mapped reconstructed block to generate a current output reconstructed block that is not identical to the current mapped reconstructed block. The current inverse mapping is different than the first inverse mapping.

In another aspect there is provided a method performed by an encoder for encoding at least a first picture. The method includes obtaining a first block of a first slice of the first picture. The method also includes applying a first mapping to the first block to generate a corresponding first mapped block, wherein the first mapped block is not identical to the first block. The method also includes generating a first mapped residual block corresponding to the first mapped block. The method also includes transmitting or storing first information (e.g., transform coefficients) for use by a decoder in reproducing the first mapped residual block. The method also includes obtaining a second block of the first slice of the first picture. The method also includes applying a second mapping to the second block to generate a corresponding second mapped block, wherein the second mapped block is not identical to the second block. The method also includes generating a second mapped residual block corresponding to the second mapped block. The method also includes transmitting or storing second information (e.g., transform coefficients) for use by the decoder in reproducing the second mapped residual block, wherein the second mapping is different from the first mapping.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is that they greatly increase the coding flexibilities and control over the coded fidelity in different parts of an image. Additionally, some embodiments use a simplified mapping function to reduce the amount of bits needed to describe the mapping function.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIGS. 4A and 4B illustrates an example picture.

FIGS. 5A and 5B illustrate an example picture.

FIG. 6 is a schematic block diagram of a decoder according to an embodiment.

FIG. 7 is a flowchart illustrating a process according to an embodiment.

FIG. 8 is a flowchart illustrating a process according to an embodiment.

FIG. 9 is a block diagram of an apparatus according to an embodiment.

### DETAILED DESCRIPTION

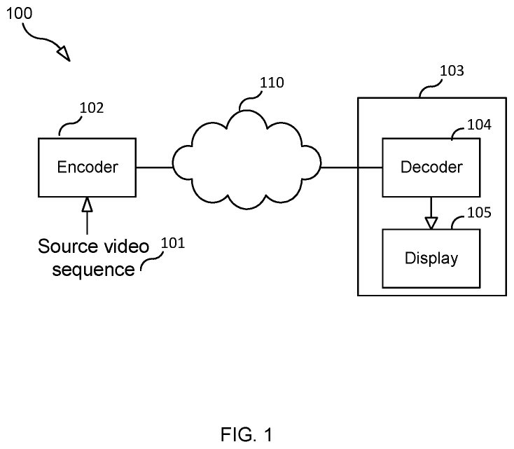

FIG. 1 illustrates a system 100 according to an embodiment. System 100 includes an encoder 102 and a decoder 104, wherein encoder 102 is in communication with decoder 104 via a network 110 (e.g., the Internet or other network). That is, encoder 102 encodes a source video sequence 101 into a bitstream comprising an encoded video sequence and transmits the bitstream to decoder 104 via network 110. In some embodiments, rather than transmitting bitstream to decoder 104, the bitstream is stored in a data storage unit. Decoder 104 decodes the pictures included in the encoded video sequence to produce video data for display. Accordingly, decoder 104 may be part of a device 103 having a display device 105. The device 103 may be a mobile device, a set-top device, a head-mounted display, and the like.

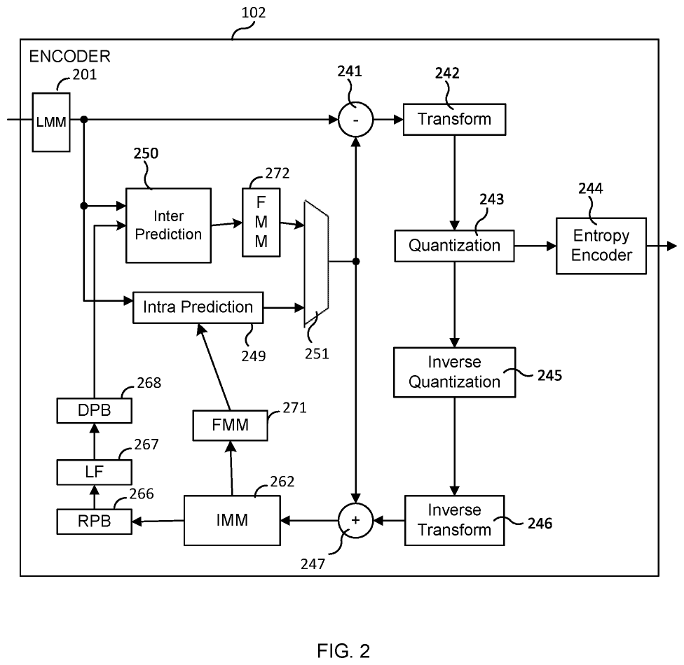

FIG. 2 illustrates functional components of encoder 102 according to some embodiments. It should be noted that encoders may be implemented differently so implementation other than this specific example can be used.

Encoder 102 includes an LMCS mapping module (LMM) 201 that maps the input blocks of the input picture from an output domain to a selected mapped domain (i.e., the LMM produces a mapped input block based on the input block). For example, LMM 201 applies a first selected mapping (mathematical function (F) (or “function” for short) or a mapping table) to an input block to perform the mapping. For instance, assume that an input block consists of values Xi,j for i=1 to N and j=1 to M (i.e., the input block is an N×M block), then the output block will consist of values Yi,j for i=1 to N and j=1 to M (i.e., the mapped input block is also an N×M block), were Yi,j=F(Xi,j). F( ) is not the identity function. Accordingly, there is at least one value Yi,j in the mapped input block where Yi,j≠Xi,j.

The output of LMM 201 for the first input block will be referred to as the first “mapped input block.” The first mapped input block is then input to a subtractor 241. The other input to the subtractor 241 is a first prediction block (i.e., the output of a selector 251, which is either an inter prediction block output by an inter predictor 250 (a.k.a., motion compensator) or an intra prediction block output by an intra predictor 249). A motion vector is utilized by inter predictor 250 for producing the inter prediction block. The intra predictor 249 computes an intra prediction block. Selector 251 selects intra prediction or inter prediction for the first mapped input block. The output from the selector 251 is input to subtractor 241 (a.k.a., error calculator 241) which also receives the first mapped input block.

The subtractor 241 calculates and outputs a first residual mapped block which is the difference in pixel values between the first mapped input block and the first prediction block. Then a forward transform 242 and forward quantization 243 is performed on the first residual mapped block as well known in the current art. This produces transform coefficients which are then encoded into the bitstream by encoder 244 (e.g., an entropy encoder) and the bitstream with the encoded transform coefficients is output from encoder 102. Note that the bitstream contains more elements than transform coefficients, but that is not illustrated in FIG. 2.

Next, encoder 102 uses the transform coefficients to produce a first mapped reconstructed block. This is done by first applying inverse quantization 245 and inverse transform 246 to the transform coefficients to produce a first reconstructed residual block and using an adder 247 to add the prediction block to the reconstructed residual block, thereby producing the first mapped reconstructed block

An inverse mapping process is then performed by an inverse mapping module (IMM) 262 applied to the first mapped reconstructed block to produce a first output reconstructed block in the output domain, which is stored in the reconstruction picture buffer (RPB) 200 and also provided to the forward mapping module 271. Forward mapping module 271 applies a second selected mapping to the output reconstructed block to produce a corresponding mapped reconstructed block. This second selected mapping may be the same as or different from the first selected mapping. Loop filtering by a loop filter (LF) 264 is optionally applied and the final decoded picture is stored in the decoded picture buffer (DPB) 266, where it can then be used by inter predictor 250 to produce an inter prediction block for a future picture to be processed. FMM 272 applies a selected mapping to this inter prediction block to produce a mapped inter prediction block.

Encoder 102 decides the details of the LMCS mapping applied by the LMM 201. This includes how the inverse mapping shall be done by decoder 104. Accordingly, encoder 102 includes syntax element values in the bitstream to convey parameter values to decoder 104 that controls the mapping performed by decoder 104. Some details on how encoder 102 decides the parameters can be found in section 3 of Lu, where two examples are given. The first is to assign more luma code words to smooth areas in the picture. The second is to adjust HDR PQ video such that fewer luma code words are assigned for dark areas. The PQ transfer function is known to use code words very densely in the darker luma range which can be compensated by LMCS.

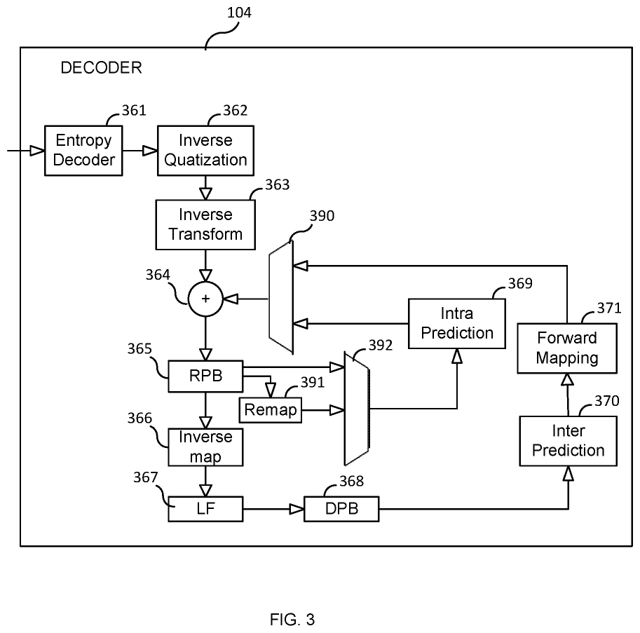

FIG. 3 illustrates functional components of decoder 104 according to some embodiments when LMCS is enabled. It should be noted that decoder may be implemented differently so implementations other than this specific example can be used.

Decoder 104 includes a decoder module 361 (e.g., an entropy decoder) that decodes from the bitstream luma transform coefficient values of a block. The transform coefficient values are subject to an inverse quantization process 362 and inverse transform process 363 to produce a current mapped residual block. This current mapped residual block is input to adder 364 that adds the current mapped residual block and a prediction block output from selector 390 to form a current mapped reconstructed block. Selector 390 either selects to output an inter prediction block or an intra prediction block. The current mapped reconstructed block is stored in a reconstruction picture buffer (RPB) 365.

The inter prediction block is generated by the inter prediction module 370 and the intra prediction block is generated by the intra prediction module 369. Intra prediction module 369 receives either mapped reconstructed values (i.e., values from one or more mapped reconstructed blocks from RPB 365) or remapped values (i.e., values obtained by applying a mapping to values from one or more mapped reconstructed blocks from RPB 365). More specifically, intra prediction module 369 receives the mapped value if the current mapped residual block is in the same domain as the mapped values, otherwise, intra prediction module 369 receives the remapped values remapping module 391 if the current mapped residual block is in different domain than the mapped values.

After all blocks of a picture have been reconstructed and stored in a RPB 365, an inverse mapping process 366 is applied to the reconstructed picture to produce a picture in the output domain. A loop filter 367 optionally applies loop filtering and the final decoded picture is stored in a decoded picture buffer (DPB) 368. Pictures are stored in the DPB for two primary reasons: 1) to wait for picture output and 2) to be used for reference (inter prediction) when decoding future pictures.

Whether intra prediction 369 or inter prediction 370 should be output by selector 390 is specified in the bitstream. Inter prediction 370 uses previously decoded pictures from DPB 368. Because those pictures are stored in the output domain, an on-the-fly forward mapping process 371 is used with the inter prediction process 370.

In VVC, the forward mapping function is signaled in an APS using a piecewise linear model. The inverse mapping function is not signaled directly but derived from the forward mapping function. A maximum of 4 LMCS APSs can be concurrently referenced within a video sequence. The APS to use for a picture is signaled in an aps_id syntax element in the picture header.

As noted above, certain challenges presently exist because, in the current version of VVC, the LMCS tool is restricted to one mapped domain per picture. This disclosure overcomes this challenge by configuring the encoder and decoder to be able to use multiple mappings within the same slice. This means that two different blocks that belong to the same slice could use different mapping functions.

While the terminology in this disclosure is described in terms of VVC, the embodiments of this disclosure also apply to any existing or future codec, which may use a different, but equivalent terminology.

Use of Two Different Mapped Domains within the Same Slice

This disclosure provides a method for decoding a first block and a current block belonging to the same slice, where the first block and the current block are decoded in separate mapping domains.

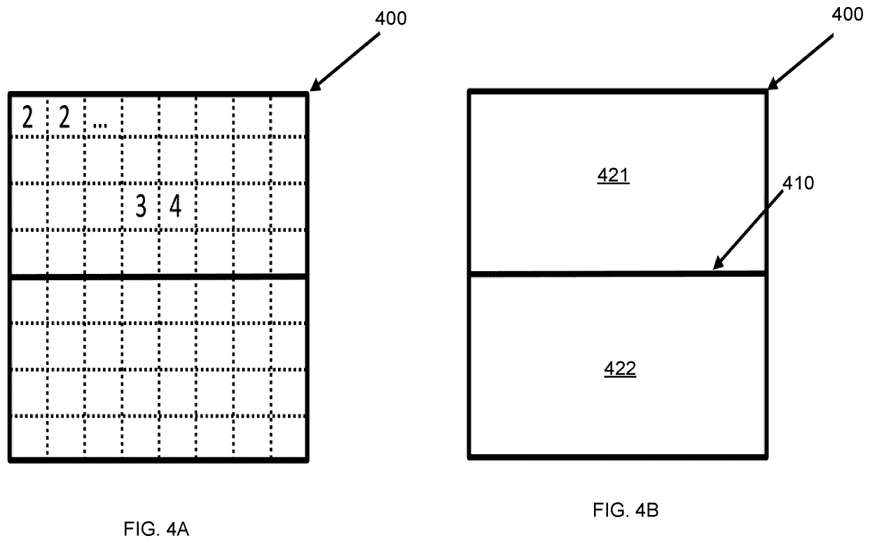

FIG. 4A shows a current picture 400 consisting of blocks (2,3,4). In VVC, the blocks (2,3,4) correspond to CTUs. A block 3 is decoded before block 4. Accordingly, when decoding block 4 block 4 will be denoted the “current block” while block 3 will be denoted the “first block.” FIG. 4B shows that the same picture 400 has a slice boundary 410 that partitions the picture 400 into two slices: slice 421 and slice 422, where both block 3 and 4 belong to the same slice (i.e., slice 421). What is proposed is to enable use of different mapped domains for blocks 3 and 4.

In this embodiment, decoder 104 may perform all or a subset of the following steps to decode, from a coded video bitstream, a first block and a current block, both belonging to the same coded slice.

For the first block, decoder 104 performs the following steps:

Step 1a: decoder 104 decodes a first mapped residual block (i.e., a block of residual values) for the first block in a first mapped domain. That is, for example, decoder decodes the transform coefficients for the first block and applies an inverse quantization and inverse transform process to produce the first mapped residual block. This first mapped residual block produced at decoder 104 corresponds to a residual block generated at encoder 102 using a mapped input block that was generated using a first mapping. Hence the first mapped residual block is referred as being in the “first mapped domain.”

Step 1b: using the first mapped residual block and a first prediction block (i.e., a first block of prediction values), decoder 104 generates a first mapped reconstructed block in the first mapped domain. That is, for example, the first mapped reconstructed block is generated by summing the residual block and the prediction block using matrix addition with optional value clipping as known in the art.

Step 1c: decoder 104 applies a first inverse mapping for the first mapped reconstructed block to generate a first output reconstructed block in an output domain.

For the current block, decoder 104 performs the following steps:

Step 2a: decoder 104 decodes a current mapped residual block for the current block in a current mapped domain. That is, for example, decoder 104 obtains the transform coefficients for the current block and applies an inverse quantization and inverse transform process to produce the current mapped residual block. This current mapped residual block produced at decoder 104 corresponds to a residual block generated at encoder 102 using a mapped input block that was generated using a current mapping, which in this example is different than the first mapping. Hence the current mapped residual block is referred as being in the “current mapped domain.”

Step 2b: decoder 104 applies the current mapped residual block to a current prediction block for the current block to generate a current mapped reconstructed block in the current mapped domain. That is, for example, the current mapped reconstructed block is generated by summing the current mapped residual block and a second prediction block (i.e., a second block of prediction values) using matrix addition with optional value clipping as known in the art.

Step 2c: decoder 104 applies a current inverse mapping for the current mapped reconstructed block to generate a current output reconstructed block in the output domain. In this example, the first mapped domain, the current mapped domain, and the output domain all differ from one another.

In one embodiment, the above mentioned prediction blocks may be determined by an inter prediction mechanism or an intra prediction mechanism.

The first output reconstructed block and the current output reconstructed block belong to the same output domain and these blocks are both part of a picture that is output by decoder 104 after all other reconstructed blocks have been decoded from the bitstream. Decoder 104 may execute other processes to the reconstructed blocks or picture, such as, but not limited to, in-loop filtering or neural network processing.

The first block and the current block may be spatially adjacent to each other, as illustrated in FIG. 4A, or located such that they are not adjacent but still belong to the same slice. Adjacent blocks are here defined as the blocks share at least a part of a border or a corner.

### The Current Block Uses Intra Prediction

In this example, the current block is adjacent to the first block and the current block is using intra prediction such that decoder 104 uses decoded values of the first block for intra prediction. This means that a conversion from the first mapped domain to the current mapped domain is done for decoding the current block. In this example, decoder 104 performs the following steps for the first block:

Step 1a: decoder 104 decodes a first mapped residual block for a first block in the first mapped domain.

Step 1b: decoder 104 applies the first mapped residual block to a first prediction for the first block to generate a first mapped reconstructed block in the first mapped domain.

Step 1c: decoder 104 applies a first inverse mapping for the first mapped reconstructed block to generate a first output reconstructed block in the output domain.

For the current block, decoder 104 performs the following steps:

Step 2a: decoder 104 determines from the bitstream that the current block is coded using an intra prediction mode.

Step 2b: decoder 104 decodes a current mapped residual block for the current block in the current mapped domain.

Step 2c: decoder 104 generates a set of intra prediction values in the current mapped domain (a.k.a., current intra prediction block) using values in the first mapped domain belonging to the first block. The generating may include converting values in the first set of values from values in the first mapped domain into corresponding values in the current mapped domain.

Step 2d: decoder 104 uses the generated current intra prediction block in an intra prediction process for the current block. The intra prediction process takes the generated set of intra prediction values and the current mapped residual block as input and produces a current mapped reconstructed block in the current mapped domain as output (e.g., summing the current mapped residual block with the current intra prediction block).

Step 2e: decoder 104 applies a current inverse mapping for the current mapped reconstructed block to generate a current output reconstructed block in the output domain.

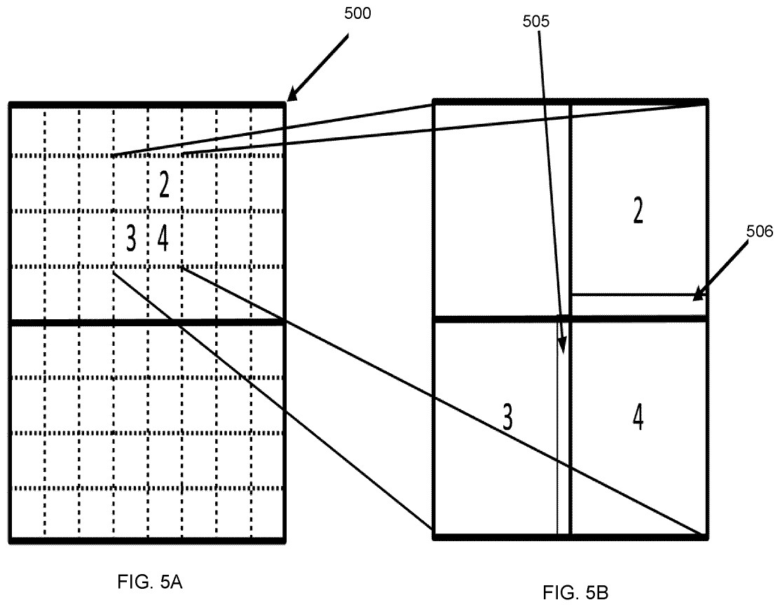

FIGS. 5A and 5B illustrate the example described above. As shown in FIG. 5A, a picture 500 comprises a first block 3, a current block 4, and a second block 2. The first block 3 contains a first set of values 505 in the first mapped domain. As previously described, decoder 104 generates a current intra prediction block for the current block using the first set of values 505. The generating may include converting values in the first set of values 505 from values in the first mapped domain into corresponding values in the current mapped domain. Decoder 104 then uses the generated current intra prediction block in the intra prediction process for the current block to generate a current mapped reconstructed block in the current mapped domain. In FIG. 5A, the first set of values 505 are values neighboring the current block 4. This is for illustration purposes only; that is, the first set of values 505 can be located anywhere in the current picture 500 as long as they belong to the same slice as the current block 4 and are used for the intra prediction process for the current block.

Decoder 104 may additionally use a second set of values 506 of the second block 2 in the process of generating the current intra prediction block for the current block. For this second block 2, decoder 104 may first decode a second residual block for the second block in a second mapped domain and then apply a second prediction for the second block in the second mapped domain to generate a second mapped reconstructed block in the second mapped domain where the second mapped reconstructed block contains the second set of values 506. The generating of the current intra prediction block for the current block may then include both converting values in the first set of values 505 as well as values in the second set of values 506 into corresponding values in the current mapped domain. The first mapped domain and the second mapped domain may be different.

### Remapping Process

As shown in FIG. 3, a remapping module 391 can be used by decoder 104 to generate a current intra prediction block (i.e., a current set of intra prediction values in the current mapped domain) from at least values from a first mapped reconstructed block in the first mapped domain. As explained above, luma transform coefficient values of a current block are decoded from the bitstream. Then inverse quantization and inverse transform processes are invoked to produce a current mapped residual block that is added to a current intra prediction block to generate a current mapped reconstructed block.

When the current block is intra coded, decoder 104 generates a current set of intra prediction values (current intra prediction block) for the current mapped residual block, wherein the generating is done at least in part by using values from a first mapped reconstructed block as input. The first mapped reconstructed block may be generated by a decoder by first decoding, from the bitstream, a first mapped residual block for the first block in a first mapped domain, followed by applying a first prediction for the first block to generate a first mapped reconstructed block in the first mapped domain.

The values from the first mapped reconstructed block are values in a first mapped domain and not in the current mapped domain, so these values are converted to values in the current mapped domain by remapping module 391 performing a remapping process that can be understood as part of the generation of the current intra prediction block that is added to the current mapped residual block to produce the current mapped reconstructed block.

The remapping module 391 may perform all or a subset of the following steps to perform the remapping process:
Step 1: obtain a first set of parameters describing the mapping between the first mapped domain and the output domain;
Step 2: obtain a current set of parameters describing the mapping between the current mapped domain and the output domain;
Step 3: use the first and current set of parameters to derive a mapping (i.e., a mapping function or mapping table); and
Step 4: use the derived mapping to convert values from the first mapped reconstructed block in the first mapped domain to values in the current mapped domain, thereby producing first remapped values, which are used by intra prediction 369 to produce the current intra prediction block.

In one alternative, the parameters describing the mapping between the first mapped domain and the output domain are third parameters describing the mapping from the output domain to the first mapped domain. Similarly, in this alternative, the parameters describing the mapping between the current mapped domain and the output domain are fourth parameters describing the mapping from the output domain to the current mapped domain. Decoder 104 then uses the decoded values of the third and fourth parameters to derive the mapping (e.g., mapping function or mapping table).

In one embodiment, the parameters describe a piecewise linear model.

In one variant of this embodiment, decoder 104 generates the current intra prediction block using both values from the first mapped reconstructed block and values from a second mapped reconstructed block for a second block.

The second mapped reconstructed block may be generated by decoder 104 by first decoding, from the bitstream, a second residual block for the second block in a second mapped domain, followed by applying a second prediction for the second block to generate a second mapped reconstructed block in the second mapped domain.

Then, the remapper 391 may perform all or a subset of the following steps to perform the remapping:
Step 1: obtain a first set of parameters describing the mapping between the first mapped domain and the output domain;
Step 2: obtain a second set of parameters describing the mapping between the second mapped domain and the output domain;
Step 3: obtain a current set of parameters describing the mapping between the current mapped domain and the output domain;
Step 4: use the first and current set of parameters to derive a first mapping; Step 5: use the second and current set of parameters to derive a second mapping;
Step 6: use the first derived mapping and the second derived mapping to convert values in the first and second mapped domain to values in the current mapped domain, respectively.

In one embodiment, decoder 104 uses the derived mapping functions or mapping tables to generate the current intra prediction block using both the first set of values in the first mapped domain and the second set of values in the second mapped domain. The first set of values here belong to the first mapped reconstructed block and the second set of values here belong to the second mapped reconstructed block.

### Using Inverse Mapping Followed by Forward Mapping

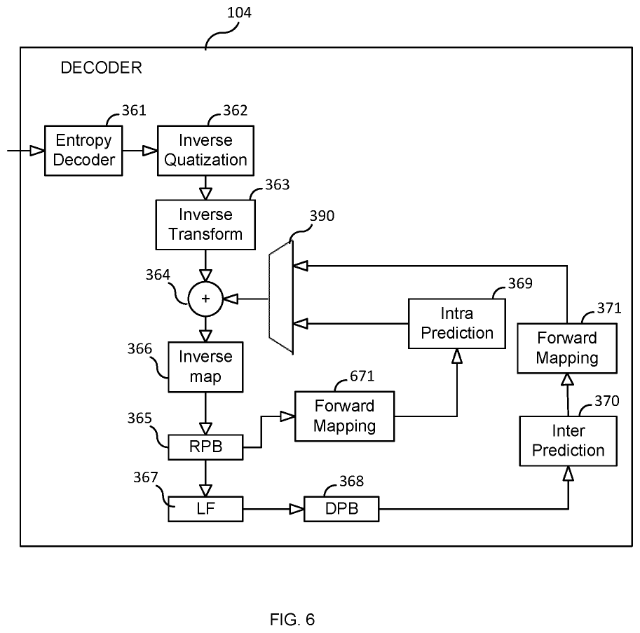

In this embodiment, the conversion from the first mapped domain to the current mapped domain is done using an inverse mapping followed by a forward mapping. That is, in one embodiment, an inverse mapping followed by a forward mapping is used for generating the current intra prediction block using values from the first mapped domain. FIG. 6 illustrates decoder 104 configured for this embodiment.

As shown in FIG. 6, luma transform coefficient values of a current block are decoded from the bitstream. Then inverse quantization and inverse transform processes are invoked to produce a current mapped residual block that is added to a current prediction block to generate a current mapped reconstructed block. An inverse mapping process is applied to the current mapped reconstructed block to produce a current output reconstructed block in the output domain. Loop filtering is optionally applied and the final decoded picture is stored in a decoded picture buffer (DPB).

When the current block is intra coded, decoder 104 generates a current intra prediction block, wherein the generating is done at least in part by using values from a first output reconstructed block as input. The values from the first output reconstructed block are values in the output domain and not in the current mapped domain, so these values are converted to values in the current mapped domain by a forward mapping 671 that can be understood as part of the generation of the current intra prediction block.

Decoder 104 may perform all or a subset of the following steps to decode, from a coded video bitstream, a first block and a current block, both belonging to the same coded slice. For the first block decoder 104 performs the following steps:
Step 1a: decoder 104 decodes a first mapped residual block for the first block in a first mapped domain;
Step 1b: decoder 104 applies the first mapped residual block to a first prediction for the first block to generate a first mapped reconstructed block in the first mapped domain; and
Step 1c: decoder 104 applies a first inverse mapping for the first mapped reconstructed block to generate a first output reconstructed block in an output domain.

For the current block, decoder 104 performs the following steps:
Step 2a: decoder 104 determines from the bitstream that the current block is coded using an intra prediction mode;
Step 2b: decoder 104 decodes a current mapped residual block for the current block in a current mapped domain;
Step 2c: decoder 104 generates a current intra prediction block using values from the first output reconstructed block. The generating may include applying the forward mapping 671 to said values from the first output reconstructed block to produce values in the current mapped domain which are then used to create the current intra prediction block;
Step 2d: decoder 104 uses the generated current intra prediction block in an intra prediction process for the current block. The intra prediction process takes the generated current intra prediction block and the current mapped residual block as input and produces a current mapped reconstructed block in the current mapped domain as output; and
Step 2e: decoder 104 applies a current inverse mapping for the current mapped reconstructed block to generate a current output reconstructed block in the output domain.

In one variant of this embodiment, the current intra prediction block is generated using values from the first output reconstructed block and values from a second output reconstructed block for a second block. For the second block decoder 104 performs the following steps:
Step 3a: decoder 104 decodes a second residual block for the second block in a second mapped domain;
Step 3b: decoder 104 applies a second prediction block for the second block to generate a second mapped reconstructed block in the second mapped domain; and
Step 3c: decoder 104 applies a second inverse mapping for the second mapped reconstructed block to generate a second output reconstructed block in an output domain.

Accordingly, in this variant decoder 104 generates the current intra prediction block using values from not only the first output reconstructed block, but also values from the second output reconstructed block. The generating may include applying the forward mapping 671 to said values from the first and second output reconstructed blocks to produce values in the current mapped domain which are then used to create the current intra prediction block.

### Still Pictures

The above embodiments can be used in the case of a still picture. In the case of a still picture there is no motion compensation step followed by forward mapping, and no step involving inter prediction. The bitstream may consist of only one coded picture and all blocks of the picture are coded using intra prediction modes. A “still picture” is defined as a single static picture. A coded still picture is always intra coded (i.e., it is not predicting from any other picture than itself). This means that all blocks in the picture are derived using intra prediction (i.e., there is no data in the coded still picture that uses prediction from any other picture). A still picture may be extracted from a set of moving pictures (i.e., extracted from a video sequence).

### Two Inter Blocks of the Same Slice Coded in Different Domains

This embodiment is a further variant in which the first block and the current block are both inter coded. In this embodiment, decoder 104 (either the variant shown in FIG. 3 or the variant shown in FIG. 6) may perform all or a subset of the following steps to decode, from a coded video bitstream, a first block and a current block, both belonging to the same coded slice:

For the first block (e.g., block 3 in FIG. 4), decoder 104 performs the following steps:
Step 1a: decoder 104 determines from the bitstream that the first block is coded using an inter prediction mode;
Step 1b: decoder 104 decodes a first mapped residual block for the first block in a first mapped domain;
Step 1c: decoder 104 generates a set of inter prediction values in the first mapped domain (i.e., a first inter prediction block) from values of a previously decoded picture (these values are in the output domain). The generating may include converting the values of the previously decoded picture from values in the output domain into corresponding values in the first mapped domain;
Step 1d: decoder 104 uses the generated first inter prediction block in an inter prediction process for the first block. The inter prediction process takes the generated first inter prediction block and the first mapped residual block as input and produces a first mapped reconstructed block in the first mapped domain as output. Steps 1c and 1d may be implemented jointly such that the inter prediction process includes the converting of values in the output domain into corresponding values in the first mapped domain; and
Step 1e: decoder 104 applies a first inverse mapping for the first mapped reconstructed block to generate a first output reconstructed block in an output domain.

For the current block (e.g., block 4 show in FIG. 4), decoder 104 performs the following steps:
Step 2a: decoder 104 determines from the bitstream that the current block is coded using an inter prediction mode;
Step 2b: decoder 104 decodes a current mapped residual block for the current block in a current mapped domain;
Step 2c: decoder 104 generates a set of inter prediction values in the current mapped domain (i.e., a current inter prediction block) from a set of values from a previously decoded picture (these values are in the output domain). The generating may include converting the values in the output domain into corresponding values in the current mapped domain;
Step 2d: decoder 104 uses the generated current inter prediction block in an inter prediction process for the current block. The inter prediction process takes the generated current inter prediction block and the current mapped residual block as input and produces a current mapped reconstructed block in the current mapped domain as output. Steps 2c and 2d may be implemented jointly such that the inter prediction process includes the converting of values in the output domain into corresponding values in the current mapped domain; and
Step 2e: decoder 104 applies a current inverse mapping for the current mapped reconstructed block to generate a current output reconstructed block in the output domain.

The first mapped domain, the current mapped domain, and the output domain all differ from one another.

### APS Signalling

The mapping between a mapped domain and the output domain may be signaled in the bitstream.

The mapping (e.g., mapping function or mapping table) may be signaled in an APS, such as for LMCS in VVC. The mapping may alternatively be signaled in another structure such as in the SPS, PPS, picture header or slice header. Described below is the case where the mapping function is signaled in APS. The APS may be signaled in the bitstream or acquired by external means.

In this embodiment, multiple APSs can be used to signal multiple (two or more) mapping functions. In one embodiment, each APS comprises a set of parameters describing a single mapping function and each APS is identified with a unique identifier (ID) referred to here as aps_id. For each block, a selector value is signaled for the block that determines, from a set of available aps_ids, which aps_id to use for the block. For example, for each block, metadata for the block may include an aps_id or information specifying an aps_id.

The mapping function described in the APS corresponding to the determined aps_id for the current block is then used to map the current block to the output domain. Likewise, for each of the other blocks in the slice there is a selector value determining an aps_id to use for that block. When predicting from another block in the slice to the current block, the values of the other block is remapped from the mapped domain of that other block to the mapped domain of the current block using the mapping function in the APS corresponding to the selected aps_ids of the current block and the mapping function in the APS corresponding to the selected aps_ids of the other block.

The example syntax shown below in Tables 3, 4 and 5 illustrates a possible implementation of the embodiment. In this example the picture header comprises a syntax element ph_num_aps_ids indicating the number of different LMCS APSs that can be used for the picture and syntax elements ph_lmcs_aps_id[i] that specify the APS IDs for the LMCS APS selected for the picture. In this example, a selector value, lmcs_aps_id_for_block, is signaled for each CTU and used to select one of the APS IDs ph_lmcs_aps_id[i] and by so indicating which APS to use for the CTU.

TABLE 3

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| rbsp_trailing_bits( ) | |
| } | |

TABLE 4

| | Descriptor |
|---|---|
| picture_header_structure( ) { | |
| ... | |
| if( sps_lmcs_enabled_flag ) { | |
| ph_lmcs_enabled_flag | u(1) |
| if( ph_lmcs_enabled_flag ) { | |
| ph_num_aps_ids | u(n) |
| for (i = 0; i < ph_num_aps_id; i++) | |
| ph_lmcs_aps_id[ i ] | u(2) |
| ... | |
| } | |
| } | |
| ... | |
| } | |

TABLE 5

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_sao_luma_used_flag \| \| sh_sao_chroma_used_flag ) | |
| sao( CtbAddrX, CtbAddrY ) | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alf_luma_prev_filter_idx | ae(v) |
| } else | |
| alf_luma_fixed_filter_idx | ae(v) |
| ... | |
| } | |
| if( ph_lmcs_enabled_flag ) | |
| lmcs_aps_id_for_block | ae(v) |
| ... | |
| if( sh_slice_type = = I && sps_qtbtt_dual_tree_intra_flag ) | |
| dual_tree_implicit_qt_split( xCtb, yCtb, CtbSizeY, 0 ) | |
| else | |
| coding_tree( xCtb, yCtb, CtbSizeY, CtbSizeY, 1, 1, 0, 0, 0, 0, 0, | |
| SINGLE_TREE, MODE_TYPE_ALL ) | |
| } | |

In the example the ph_num_aps_ids syntax element is signaled with a fixed number of bits, n, but other descriptors may be used as well. Likewise, the lmcs_aps_id_for_block syntax element is context-adaptive arithmetic entropy coded (ae (v)), but other descriptors may be used as well. For example, if only two APS IDs are allowed per CTU the lmcs_aps_id_for_block syntax element could be a binary flag selecting one of the two APS IDs. In the example, the selector value lmcs_aps_id_for_block is signaled per CTU, but it is to be understood that it is just an example and that the selector value could be signaled at other levels, such as the CU level.

In some embodiments, the selector value may indicate that the same aps_id as in the previously decoded block is to be used for the current block. In some embodiments, the indicator value may indicate that no mapping is performed for the block. This is illustrated by the following table:

TABLE 6

| lmcs_aps_id_{—} | |
|---|---|
| for_block | Interpretation |
| 0 | No aps_id is used for the current block |
| 10 | Use the same aps_id as the previously decoded |
| | block |
| 110 | Use first aps_id in the list of aps_ids |
| 1110 | Use second aps_id in the list of aps_ids |
| . . . | . . . |

Decoder 104 may perform all or a subset of the following steps to perform the remapping:
Step 1: decoder 104 decodes a first APS from the bitstream or acquires the first APS by external means, wherein the first APS comprises a first set of mapping parameters;
Step 2: decoder 104 decodes a second APS from the bitstream or acquires the second APS by external means, wherein the second APS comprises a second set of mapping parameters;
Step 3: decoder 104 decodes a first aps_id from the bitstream, wherein the first aps_id identifies the first APS. The first aps_id may be decoded from a slice header of a current slice or from another structure such as a picture header, PPS, SPS or VPS;
Step 4: decoder 104 decodes a second aps_id from the bitstream, wherein the second aps_id identifies the second APS. The second aps_id may be decoded from a slice header of a current slice or from another structure such as a picture header, PPS, SPS or VPS;
Step 5: decoder 104 decodes a first selector value for a first block in the slice from one or more syntax elements in the slice, wherein the first selector value determines which one of the first aps_id and the second aps_id to be used for the first block;
Step 6: decoder 104 decodes a current selector value for a current block in the slice from one or more syntax elements in the slice, wherein the second selector value determines which one of the first aps_id and the second aps_id to be used for the current block;
Step 7: decoder 104 uses the mapping parameters included in the APS corresponding to the aps_id selected for the first block to derive a first mapping (i.e., a first mapping function or first mapping table);
Step 8: decoder 104 uses the mapping parameters included in the APS corresponding to the aps_id selected for the current block to derive a current mapping (i.e., a current mapping function or current mapping table);
Step 9: decoder 104 uses the first mapping to map values from the first domain to the output domain (i.e., the first mapping is used in the inverse mapping process 366) or uses the first mapping to map values from the output domain to the first domain (i.e., the first mapping is used in the forward mapping process 371); and
Step 10: decoder 104 uses the current mapping to map values from the current domain to the output domain (i.e., the current mapping is used in the inverse mapping process 366) or uses the current mapping to map values from the output domain to the current domain (i.e., the current mapping is used in the forward mapping process 371).

If the derived first mapping is used in the forward mapping process 371 (i.e., the first mapping is a “forward” mapping), then decoder will derive, based on the forward mapping, an inverse mapping for the first block (i.e., a mapping to use in the inverse mapping process 366 for the first block), and vice-versa. Similarly, if the derived current mapping is a forward mapping, then decoder will derive, based on the forward mapping, an inverse mapping for the current block, and vice-versa.

In some embodiments, decoder 104 uses first mapping and the current mapping to derive a third mapping that maps from the first domain to the current domain. This third mapping will be used by the remapping module 391 as described above. That is, for example, decoder 104 uses the third mapping to generate the current intra prediction block using values in the first mapped domain (i.e., values in the first mapped reconstructed block).

In some embodiments, an APS (or another structure such as picture header, PPS, SPS or VPS) comprises a set of parameters describing two or more mapping functions. To be able to select a specific mapping function, each of the two or more mapping functions are identified by a function identifier, e.g. aps_map_func_id, or an index value, e.g. i that selects a mapping function in a list of possible mapping functions, e.g, aps_mapping_functions[i]. Instead of only using an aps_id to identify the mapping function as above, the function identifier or the index value, is also signaled for a block and is used to identify the mapping function to be used for the block. This is illustrated with the following syntax:

TABLE 7

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| ... | |
| else if( aps_params_type = = LMCS_APS ) { | |
| lmcs_data( ) | |
| num_aps_mapping_functions | u(n) |
| for (i = 0; i < num_aps_mapping_functions; i++) | |
| aps_mapping_functions[ i ] | u(n) |
| } | |
| ... | |
| } | |

TABLE 8

| | Descriptor |
|---|---|
| picture_header_structure( ) { | |
| ... | |
| if( sps_lmcs_enabled_flag ) { | |
| ph_lmcs_enabled_flag | u(1) |
| if( ph_lmcs_enabled_flag ) { | |
| ph_num_aps_ids | u(n) |
| for (i = 0; i < ph_num_aps_id; i++) | |
| ph_lmcs_aps_id[ i ] | u(2) |
| ... | |
| } | |
| } | |
| ... | |
| } | |

TABLE 9

| | Descriptor |
|---|---|
| coding_tree_unit( ) { | |
| ... | |
| } | |
| if( ph_lmcs_enabled_flag ) { | |
| lmcs_aps_id_for_block | ae(v) |
| lmcs_aps_map_func_id | ae(v) |
| } | |
| ... | |
| if( sh_slice_type = = I && sps_qtbtt_dual_tree_intra_flag ) | |
| dual_tree_implicit_qt_split( xCtb, yCtb, CtbSizeY, 0 ) | |
| else | |
| coding_tree( xCtb, yCtb, CtbSizeY, CtbSizeY, 1, 1, 0, 0, 0, 0, 0, | |
| SINGLE_TREE, MODE_TYPE_ALL ) | |
| } | |

### Example Mapping Functions

As described above, the set of parameters describing a mapping between a mapped domain and the output domain may describe a piecewise linear model. This is how the mapping function is defined in LMCS in VVC. However, defining multiple piecewise linear models per picture may be relatively expensive in terms of bit cost.

Accordingly, in some embodiments, the set of mapping parameters describe a mapping function from a small set of predefined, candidate mapping functions. For example, there may be 16 predefined candidate functions, all with different characteristics (e.g., some mapping functions would emphasize fidelity for dark values, some would emphasize fidelity for bright values, some would emphasize the middle range of values, and some would emphasize fidelity for multiple ranges of values). Selecting one of these 16 predefined mapping functions would at most cost 4 bits on average.

In other embodiments, the set of mapping parameters describe a mapping function for a function with a small number of adjustment parameters. One example of such a function is:

$$f ( x ) = \frac{1}{d} {log}_{2} ( 1 + x \cdot ( {2}^{d} - 1 ) ) : x ∈ [ 0 , 1 ]$$

which takes on different exponential or logarithmical curves depending on the value of d and for which the output f(x) will always be between 0 and 1. In this example, only the parameter d needs to be signaled to determine the mapping function. For instance, to map a 10-bit value of 357 using f(x) with d=−3 we would get

$$f ( 357 / 1024 ) \cdot 1024 = \frac{1}{- 3} {log}_{2} ( 1 + 357 / 1024 \cdot ( {2}^{- 3} - 1 ) ) \cdot 1024 = 179.$$

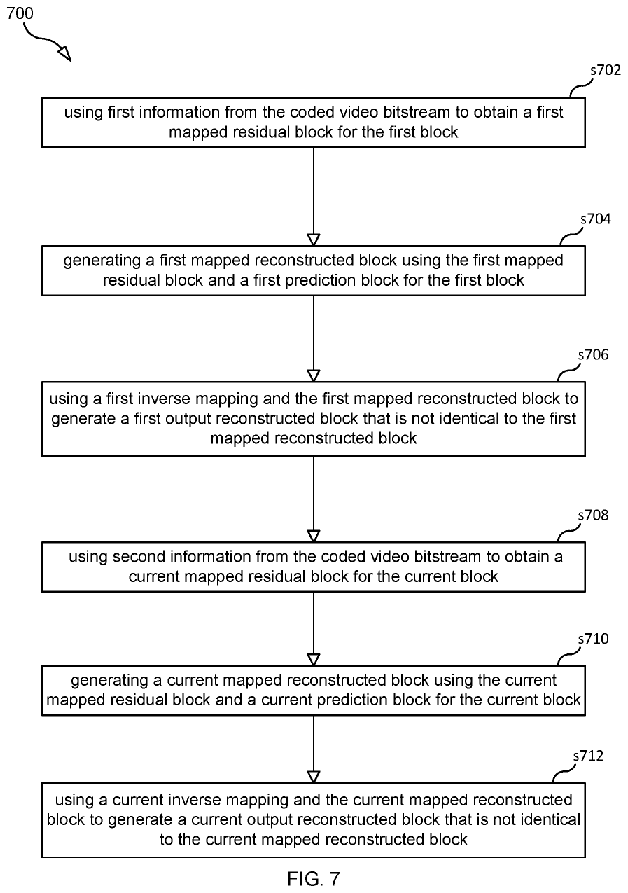

FIG. 7 is a flow chart illustrating a process 700, according to an embodiment, for decoding, from a coded video bitstream, a first block of a first coded slice of a first picture and a current block of the first coded slice of the first picture. Process 700 is performed by decoder 104. Process 700 may begin in step s702.

Step s702 comprises using first information from the coded video bitstream to obtain a first mapped residual block for the first block.

Step s704 comprises generating a first mapped reconstructed block using the first mapped residual block and a first prediction block for the first block.

Step s706 comprises using a first inverse mapping and the first mapped reconstructed block to generate a first output reconstructed block that is not identical to the first mapped reconstructed block.

Step s708 comprises using second information from the coded video bitstream to obtain a current mapped residual block for the current block.

Step s710 comprises generating a current mapped reconstructed block using the current mapped residual block and a current prediction block for the current block.

Step s712 comprises using a current inverse mapping and the current mapped reconstructed block to generate a current output reconstructed block that is not identical to the current mapped reconstructed block, wherein the current inverse mapping is different than the first inverse mapping.

In some embodiments, the first inverse mapping is a first inverse mapping function or a first inverse mapping table, and the current inverse mapping is a current inverse mapping function or a current inverse mapping table.

In some embodiments, the first information was generated using, among other things, a first forward mapping, the second information was generated using, among other things, a current forward mapping that is different than the first forward mapping, the first inverse mapping is the inverse of the first forward mapping, and the current inverse mapping is the inverse of the current forward mapping.

In some embodiments the process further includes generating the current prediction block, wherein generating the current prediction block comprises: obtaining a first set of values associated with the first block and generating a first set of intra prediction values using a third mapping and the first set of values, and the current prediction block comprises the first set of intra prediction values.

In some embodiments, the first set of values are from i) the first mapped reconstructed block or ii) the first output reconstructed block, and the third mapping maps the first set of values to corresponding values in a current mapped domain. In some embodiments, the first set of values are from the first output reconstructed block, and the third mapping is the current forward mapping.

In some embodiments, the coded video bitstream is a still picture bitstream that comprises only one picture and wherein the first prediction block and the current prediction block are derived using intra prediction.

In some embodiments the process further includes generating the first prediction block, wherein generating the first prediction block comprises: obtaining a first set of values associated with a previously decoded picture and generating a first set of inter prediction values using a first forward mapping and the first set of values associated with the previously decoded picture, and the first prediction block comprises the first set of inter prediction values. In some embodiments the process further includes generating the current prediction block, wherein generating the current prediction block comprises: obtaining a second set of values associated with the previously decoded picture and generating a second set of inter prediction values using a second forward mapping and the second set of values associated with the previously decoded picture, the current prediction block comprises the second set of inter prediction values, and the first forward mapping is different than the second forward mapping.

In some embodiments the process further includes: i) obtaining a first parameter set (e.g., first APS) from the bitstream, wherein the first parameter set comprises a first set of mapping parameters from which the first inverse mapping can be derived; and ii) obtaining a second parameter set (e.g., second APS) from the bitstream, wherein the second parameter set comprises a second set of mapping parameters from which the current inverse mapping can be derived. In some embodiments the process also includes obtaining from the bitstream a slice (e.g., VCL NAL unit) comprising a slice header and slice data comprising a first set of one or more syntax elements associated with the first block and a second set of one or more syntax elements associated with the current block; decoding from the first set of syntax elements a first selector value for the first block; and decoding from the second set of syntax elements a current selector value for the current block, wherein the first selector value indicates the first parameter set and the current selector value indicates the second parameter set. In some embodiments the process also includes deriving the first inverse mapping from the first set of parameters and deriving the current inverse mapping from the second set of parameters.

In some embodiments, the first inverse mapping is: i) a piecewise linear model, ii) a function selected from a set of predefined mapping functions, or iii) a function with one or more signaled function adjustment parameters.

In some embodiments the process also includes using third information from the coded video bitstream to obtain a second mapped residual block for a second block belonging to the same coded slice as the first block and the current block; generating a second mapped reconstructed block using the second mapped residual block and a second prediction for the second block; using a second inverse mapping and the second mapped reconstructed block to generate a second output reconstructed block, wherein the second inverse mapping is different than the first inverse mapping and the current inverse mapping; and using values from either the second output reconstructed block or the second mapped reconstructed block to generate the current prediction block.

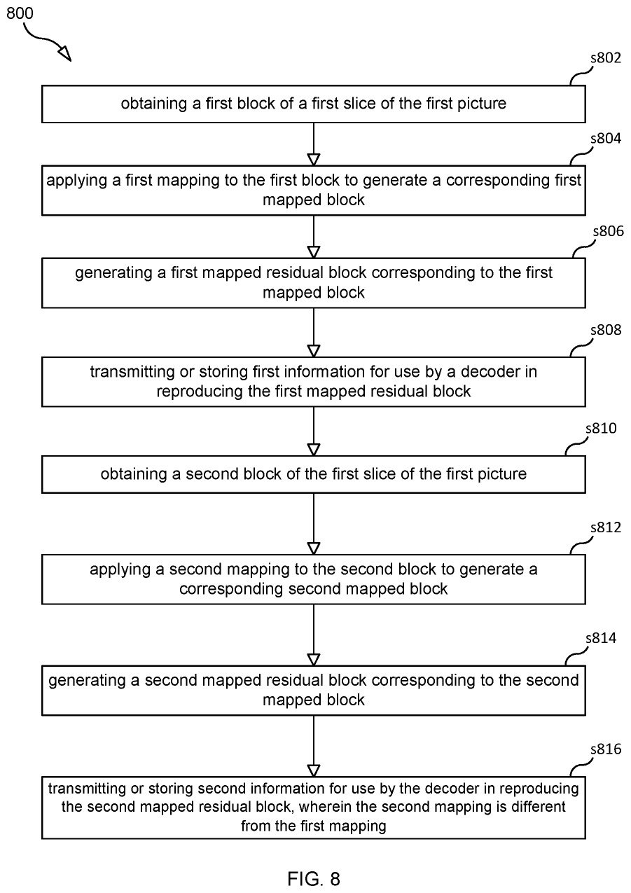

FIG. 8 is a flow chart illustrating a process 800, according to an embodiment, for encoding at least a first picture. Process 800 is performed by encoder 102. Process 800 may begin in step s802.

Step s802 comprises obtaining a first block of a first slice of the first picture.

Step s804 comprises applying a first mapping to the first block to generate a corresponding first mapped block that is not identical to the first block. For example, if the first block is a first N×M block comprising values Xi,j for i=1 to N and j=1 to M, then the corresponding first mapped block is an N×M block comprising values Yi,j for i=1 to N and j=1 to M where Yi,j=F(Xi,j) for i=1 to N and j=1 to M, where F is predetermined function.

Step s806 comprises generating a first mapped residual block corresponding to the first mapped block.

Step s808 comprises transmitting or storing first information (e.g., transform coefficients) for use by a decoder in reproducing the first mapped residual block.

Step s810 comprises obtaining a second block of the first slice of the first picture.

Step s812 comprises applying a second mapping to the second block to generate a corresponding second mapped block that is not identical to the second block.

Step s814 comprises generating a second mapped residual block corresponding to the second mapped block.

Step s816 comprises transmitting or storing second information (e.g., transform coefficients) for use by the decoder in reproducing the second mapped residual block, wherein the second mapping is different from the first mapping.

In some embodiments the process 800 further includes generating a second prediction block for use in generating the second mapped residual block, wherein generating the second prediction block comprises obtaining a first set of values associated with the first block and generating a first set of intra prediction values using an intra prediction process, a third mapping, and the first set of values, the third mapping being different than the first mapping, and the second prediction block comprises the first set of intra prediction values.

In some embodiments, the first set of values are derived from the first mapped residual block. In some embodiments, the third mapping is one of the second mapping, a function of at least the second mapping, or a function of both the first mapping and the second mapping.

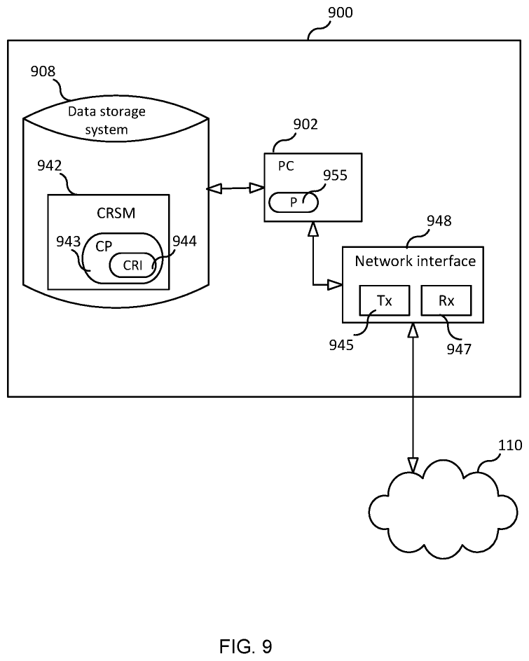

FIG. 9 is a block diagram of an apparatus 900 for implementing encoder 102 and/or decoder 104, according to some embodiments. When apparatus 900 implements encoder 102, apparatus 900 may be referred to as a “encoder apparatus 900,” and when apparatus 900 implements decoder 104, apparatus 900 may be referred to as a “decoding apparatus 900.” As shown in FIG. 9, apparatus 900 may comprise: processing circuitry (PC) 902, which may include one or more processors (P) 955 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 900 may be a distributed computing apparatus); at least one network interface 948 comprising a transmitter (Tx) 945 and a receiver (Rx) 947 for enabling apparatus 900 to transmit data to and receive data from other nodes connected to a network 110 (e.g., an Internet Protocol (IP) network) to which network interface 948 is connected (directly or indirectly) (e.g., network interface 948 may be wirelessly connected to the network 110, in which case network interface 948 is connected to an antenna arrangement); and a storage unit (a.k.a., “data storage system”) 908, which may include one or more non-volatile storage devices and/or one or more volatile storage devices. In embodiments where PC 902 includes a programmable processor, a computer readable storage medium (CRSM) 942 may be provided. CRSM 942 stores a computer program (CP) 943 comprising computer readable instructions (CRI) 944. CRSM 942 may be a non-transitory computer readable storage medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes apparatus 900 to perform steps described herein (e.g., steps described herein with reference to the flow charts). In other embodiments, apparatus 900 may be configured to perform steps described herein without the need for code. That is, for example, PC 902 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a decoder for decoding, from a coded video bitstream, a first block of a first coded slice of a first picture and a current block of the first coded slice of the first picture, the method comprising:
using first information from the coded video bitstream to obtain a first mapped residual block for the first block;
generating a first mapped reconstructed block using the first mapped residual block and a first prediction block for the first block;
using a first inverse mapping and the first mapped reconstructed block to generate a first output reconstructed block that is not identical to the first mapped reconstructed block;
using second information from the coded video bitstream to obtain a current mapped residual block for the current block;
generating a current prediction block for the current block;
generating a current mapped reconstructed block using the current mapped residual block and the current prediction block for the current block; and
using a current inverse mapping and the current mapped reconstructed block to generate a current output reconstructed block that is not identical to the current mapped reconstructed block, wherein
the current inverse mapping is different than the first inverse mapping, and
generating the current prediction block comprises:
i) obtaining a first set of values associated with the first block and generating a first set of intra prediction values using a third mapping and the first set of values, wherein the current prediction block comprises the first set of intra prediction values, or
ii) performing a process that comprises:
using third information from the coded video bitstream to obtain a second mapped residual block for a second block belonging to the same coded slice as the first block and the current block;
generating a second mapped reconstructed block using the second mapped residual block and a second prediction for the second block;
using a second inverse mapping and the second mapped reconstructed block to generate a second output reconstructed block, wherein the second inverse mapping is different than the first inverse mapping and the current inverse mapping; and
using values from either the second output reconstructed block or the second mapped reconstructed block to generate the current prediction block.

2. The method of claim 1, wherein
the first inverse mapping is a first inverse mapping function or a first inverse mapping table, and
the current inverse mapping is a current inverse mapping function or a current inverse mapping table.

3. The method of claim 1, wherein
the first information was generated using, among other things, a first forward mapping,
the second information was generated using, among other things, a current forward mapping that is different than the first forward mapping,
the first inverse mapping is the inverse of the first forward mapping, and
the current inverse mapping is the inverse of the current forward mapping.

4. (canceled)

5. The method of claim 1, wherein
the first set of values are from i) the first mapped reconstructed block or ii) the first output reconstructed block, and
the third mapping maps the first set of values to corresponding values in a current mapped domain.

6. The method of claim 5, wherein
the first set of values are from the first output reconstructed block, and
the third mapping is the current forward mapping.

7. The method of claim 1, wherein the coded video bitstream is a still picture bitstream that comprises only one picture and wherein the first prediction block and the current prediction block are derived using intra prediction.

8-9. (canceled)

10. The method of claim 1, further comprising:
obtaining a first parameter set from the bitstream, wherein the first parameter set comprises a first set of mapping parameters from which the first inverse mapping can be derived; and
obtaining a second parameter set from the bitstream, wherein the second parameter set comprises a second set of mapping parameters from which the current inverse mapping can be derived.

11. The method of claim 10, further comprising:
obtaining from the bitstream a slice comprising a slice header and slice data comprising a first set of one or more syntax elements associated with the first block and a second set of one or more syntax elements associated with the current block;
decoding from the first set of syntax elements a first selector value for the first block; and
decoding from the second set of syntax elements a current selector value for the current block, wherein
the first selector value indicates the first parameter set, and
the current selector value indicates the second parameter set.

12. The method of claim 11, further comprising:
deriving the first inverse mapping from the first set of parameters; and
deriving the current inverse mapping from the second set of parameters.

13. The method of claim 1, wherein
the first inverse mapping is: i) a piecewise linear model, ii) a function selected from a set of predefined mapping functions, or iii) a function with one or more signaled function adjustment parameters.

14. (canceled)

15. A method performed by an encoder for encoding at least a first picture, the method comprising:
obtaining a first block of a first slice of the first picture;
applying a first mapping to the first block to generate a corresponding first mapped block, wherein the first mapped block is not identical to the first block;
generating a first mapped residual block corresponding to the first mapped block;
transmitting or storing first information for use by a decoder in reproducing the first mapped residual block;
obtaining a second block of the first slice of the first picture;
applying a second mapping to the second block to generate a corresponding second mapped block, wherein the second mapped block is not identical to the second block;
generating a second mapped residual block corresponding to the second mapped block; and
transmitting or storing second information for use by the decoder in reproducing the second mapped residual block, wherein
the second mapping is different than the first mapping.

16. The method of claim 15, further comprising generating a second prediction block for use in generating the second mapped residual block, wherein
generating the second prediction block comprises obtaining a first set of values associated with the first block and generating a first set of intra prediction values using an intra prediction process, a third mapping, and the first set of values, the third mapping being different than the first mapping, and
the second prediction block comprises the first set of intra prediction values.

17. The method of claim 16, wherein the first set of values are derived from the first mapped residual block.

18. The method of claim 17, wherein the third mapping is one of the second mapping, a function of at least the second mapping, or a function of both the first mapping and the second mapping.

19. A non-transitory computer readable storage medium storing a computer program comprising instructions which when executed by processing circuitry of a decoder causes the decoder to perform the method of claim 1.

20. A non-transitory computer readable storage medium storing a computer program comprising instructions which when executed by processing circuitry of an encoder causes the encoder to perform the method of claim 15.

21. (canceled)

22. A decoder apparatus, the decoder apparatus comprising:
memory; and
processing circuitry, wherein the decoder apparatus is configured to:
use first information from the coded video bitstream to obtain a first mapped residual block for the first block;
generate a first mapped reconstructed block using the first mapped residual block and a first prediction block for the first block;
use a first inverse mapping and the first mapped reconstructed block to generate a first output reconstructed block that is not identical to the first mapped reconstructed block;
use second information from the coded video bitstream to obtain a current mapped residual block for the current block;
generate a current prediction block for the current block;
generate a current mapped reconstructed block using the current mapped residual block and the current prediction block for the current block; and
use a current inverse mapping and the current mapped reconstructed block to generate a current output reconstructed block that is not identical to the current mapped reconstructed block, wherein
the current inverse mapping is different than the first inverse mapping, and
generating the current prediction block comprises:
i) obtaining a first set of values associated with the first block and generating a first set of intra prediction values using a third mapping and the first set of values, wherein the current prediction block comprises the first set of intra prediction values, or
ii) performing a process that comprises:
using third information from the coded video bitstream to obtain a second mapped residual block for a second block belonging to the same coded slice as the first block and the current block;
generating a second mapped reconstructed block using the second mapped residual block and a second prediction for the second block;
using a second inverse mapping and the second mapped reconstructed block to generate a second output reconstructed block, wherein the second inverse mapping is different than the first inverse mapping and the current inverse mapping; and
using values from either the second output reconstructed block or the second mapped reconstructed block to generate the current prediction block.

23. (canceled)

24. An encoder apparatus, the encoder apparatus comprising:
memory; and
processing circuitry, wherein the encoder apparatus is configured to:
obtain a first block of a first slice of a first picture;
apply a first mapping to the first block to generate a corresponding first mapped block, wherein the first mapped block is not identical to the first block;
generate a first mapped residual block corresponding to the first mapped block;
transmit or storing first information for use by a decoder in reproducing the first mapped residual block;
obtain a second block of the first slice of the first picture;
apply a second mapping to the second block to generate a corresponding second mapped block, wherein the second mapped block is not identical to the second block;
generate a second mapped residual block corresponding to the second mapped block; and
transmit or storing second information for use by the decoder in reproducing the second mapped residual block, wherein
the second mapping is different from the first mapping.

25. (canceled)
